(19) United States
(12) Patent Application Publication
(10) Pub. No.: US 2005/0184480 A1
(43) Pub. Date: Aug. 25, 2005

(54) Boot shield

(76) Inventors: George E. Arlt, Midland, MI (US); Timothy J. Buscarino, Saginaw, MI (US); Elton J. Fisch, Caro, MI (US)

Correspondence Address: DELPHI TECHNOLOGIES, INC., M/C 480-410-202, PO BOX 5052, TROY, MI, 48007, US

(21) Appl. No.: 10/788,075

(22) Filed: Feb. 25, 2004

(51) Int. Cl. B60G 1/00

(52) U.S. Cl. 280/89.12

(57) ABSTRACT

A boot shield for protecting a boot includes a perimetrically continuous tube member open at first and second ends defining a length thereof; and a plurality of retention features extending radially inwardly from a perimeter defining the tube member, the plurality of retention features configured to resiliently engage a valley defined by a boot convolute of the boot disposed in a hollow cavity defined by the tube member, the plurality of retention features configured to secure the tube member to the boot axially while allowing the tube member to rotate relative to the boot. In an exemplary embodiment, the boot shield is a molded cylinder having integrally molded retention features equidistantly spaced from one another disposed at a one end of the cylinder and an opposite end of the cylinder flared radially outwardly.

### TECHNICAL FIELD

This disclosure relates to a protective device for a steering gear apparatus and, more specifically, to a boot shield for a boot seal associated with a steering gear tie rod and actuator.

### BACKGROUND

The inner tie rod of a vehicle steering system is connected to a steering arm and to the rack of a rack and pinion steering system. The connection between the inner tie rod and the rack must accommodate pivotal movement about a plurality of axes. A ball and socket connection is therefore the preferred connection.

Ball and socket connections can wear out occasionally. Excessive wear, if it occurs, is generally due to lack of lubrication, extensive use over a period of years, excessive forces applied to the joint, or damage to a boot seal configured to seal the ball and socket from environmental contaminants. Such wear may involve failure of the threads that hold either the ball or the socket in place, or failure of the inner tie rod housing crimp that holds the ball in the inner tie rod housing or socket. A worn or loose ball and socket as well as loose threads can be identified by excess play in the steering wheel when the ball and socket are part of a front wheel steering system. Detection of a worn ball and socket or loose thread connections in a rear wheel steering system of a vehicle with four wheel steering is more difficult. Looseness in a rear wheel steering system, indicating that the threads or the housing crimp that hold a ball in the housing need to be inspected or repaired, may not be detectable by turning the steering wheel. Furthermore, the front wheel steering system and, more particularly, the rear wheel steering system is susceptible to stone impingement and other types of damage from road debris or off road usage.

The front steered wheels of a vehicle have a steering geometry that includes caster, camber and toe in. This geometry tends to turn the steered front wheels to a position that directs a vehicle straight forward if the operator releases the steering wheel or if there is a steering linkage failure.

The rear wheels of a vehicle with four wheel steering generally have negative caster. A failure in the steering linkage of the rear wheels of a vehicle may therefore make the vehicle unstable. Therefore, a boot shield covering a boot of a rear wheel steering system helps to maintain the integrity of the boot and protect the ball and socket interface against premature wear due to stone impingement and any other type of damage to the boot from road debris or off road usage.

A current boot shield 2 used on the steering linkage of the rear wheels of a vehicle is depicted in FIG. 1. The current boot shield 2 is configured having a clam shell design including a living hinge 4 located between two half cylinders 6 defining the boot shield 2. The two half cylinders 6 are rotated toward each other about the living hinge 4 over a flexible boot. There are three features 8 on one half cylinder 6 opposite the living hinge 4 that engage three complimentary configured features 9 on the other half cylinder 6 to connect and lock the two half cylinders 6 together forming a cylindrical shield over the boot it is designed to protect. However, the living hinge 4 and six snap features 8, 9 are costly to mold, and difficult to mold and assemble, as well as providing significant part-to-part variation.

### SUMMARY

The above discussed and other drawbacks and deficiencies are over come or alleviated by a boot shield for protecting a boot includes a perimetrically continuous or integrally closed tube member open at first and second ends defining a length thereof; and a plurality of retention features extending radially inwardly from a perimeter defining the tube member, the plurality of retention features configured to resiliently engage a valley defined by a boot convolute of the boot disposed in a hollow cavity defined by the tube member, the plurality of retention features configured to secure the tube member to the boot axially while allowing the tube member to rotate relative to the boot.

In an exemplary embodiment, the boot shield is a molded cylinder open at both ends having integrally molded retention features equidistantly spaced from one another disposed at a one end of the cylinder and an opposite end of the cylinder flared radially outwardly. The boot shield is preferably employed as a slip on protection system for a boot covering an inner tie rod and steering actuator interface, where the boot includes a first end sealingly engaged with a housing of the steering actuator and a second end sealingly engaged with the inner tie rod.

The above-discussed and other features and advantages of the present invention will be appreciated and understood by those skilled in the art from the following description and drawings.

### BRIEF DESCRIPTION OF THE DRAWINGS

Referring to the exemplary drawings wherein like elements are numbered alike in the several FIGURES:

FIG. 1 is a perspective view of a prior art boot shield in a clam shell configuration;

FIG. 2 is a perspective view of a rack and pinion drive for a vehicle steering system without an inner tie rod;

FIG. 3 is an enlarged vertical sectional view of the inner end of an inner tie rod assembly having a boot and a boot shield in accordance with an exemplary embodiment of the invention;

FIG. 4 is a front view of the boot shield of FIG. 3 illustrating retention features extending radially inwardly for engagement in a valley defined by convolutes of the boot;

FIG. 5 is a cross section view along A-A of FIG. 4; and

FIG. 6 is an enlarged view of the retention feature illustrated in circle B of FIG. 5.

### DETAILED DESCRIPTION

Referring to FIG. 2, the rack and pinion vehicle steering assembly 10 includes a rack and pinion housing 12. A steering rack 14 is slideably mounted in the housing 12 for axial movement along a rack axis 16. A pinion gear 18, on a pinion shaft 20 journaled in the housing 12, drives the rack 14 back and forth along the rack axis 16. The pinion shaft 20 is driven by a controller when the steering rack 14 steers the rear wheels of a vehicle with four wheel steering. When the steering rack 14 steers the front wheels of a vehicle, the pinion shaft 20 is connected to a vehicle steering wheel by a steering shaft assembly (not shown). The pinion gear 18 has pinion gear teeth that mesh with rack teeth (both not shown).

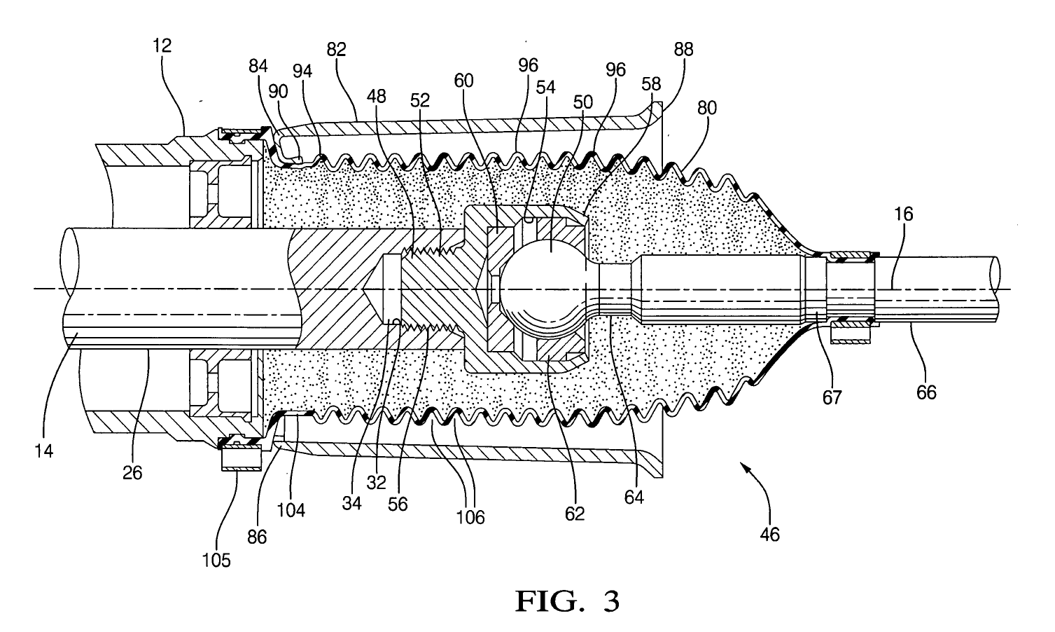

The steering rack 14 as shown in FIG. 2 has a steering rack first end 26 and a steering rack second end 28. The rack 14 can have an inner tie rod assembly 46 (FIG. 3) attached to the rack first end 26 and another inner tie rod attached to the rack second end 28. Only one inner tie rod assembly 46 is attached to some steering racks 14. Only one inner tie rod assembly 46 is shown in the drawing. An inner tie rod attached to the steering rack second end 28, in a system having two inner tie rods, would be identical to the inner tie rod assembly 46 attached to steering rack first end 26.

The steering rack first end 26 has a steering rack bore 32 that is concentric with the rack axis 16. The rack bore 32 is preferably a threaded rack bore 34.

The inner tie rod connector assembly 46 includes an inner tie rod housing 48 and an inner end ball 50. The housing 48 has a shank 52 and a housing chamber 54. A shank threaded portion 56 screws into the threaded rack bore 34 to secure the tie rod housing 48 to the steering rack 14. The housing chamber 54 has an open end 58. A first bearing 60 is mounted in the chamber 54. The inner end ball 50 is seated on the first bearing 60. A second bearing ring 62 is telescopically received on the ball shank 64, seated on the inner end ball 50 and received in the housing chamber 54. The open end 58 of the housing chamber 54 is crimped to retain the second bearing ring 62 and the inner end ball 50 in the housing chamber.

The ball shank 64 is an integral part of the tie rod inner end 67 of the inner rod 66.

A flexible boot 80 is connected to the rack and pinion housing 12 and to the inner rod 66 in positions in which the inner tie rod assembly 46 is sealed from water, dust and other contaminants.

An exemplary embodiment of a boot shield 82 is disposed over flexible boot 80 to protect flexible boot 80 from stone impingement and any other type of damage caused by road debris or off road utility. Boot shield 82 is a perimetrically continuous tube member open at first and second ends defining a length thereof. In an exemplary embodiment, boot shield 82 is preferably a continuously formed cylinder having a plurality of spaced retention features or fingers 84 disposed at one end 86 and flared out an opposite end 88. However, boot shield 82 may be a tube member being hollow and elongated in any geometric shape other than a cylinder described in an exemplary embodiment. For example, boot shield may be an elongated triangular or more sided tube member. Furthermore, fingers 84 are not limited to extending from one end of boot shield 82, as fingers 84 may circumferentially extend from an intermediate portion defining boot shield 82.

An end 90 defining each retention feature or finger 84 shown in FIG. 3 appears to be cutting into boot 80. This is because finger 84 of the boot shield 82 is shown in the “as molded” position in FIG. 3. In actuality, fingers 84 will deflect so that there is interference between each finger 84 and boot 80, which holds boot shield 82 in place via a profile of boot 80 engaged with housing 12 and a first bellow or convolute 94 of a plurality of bellows or convolutes 96 defining a substantial length of boot 80. End 88 is flared out to provide angular movement of tie rod inner end 67 and boot 80 disposed thereover.

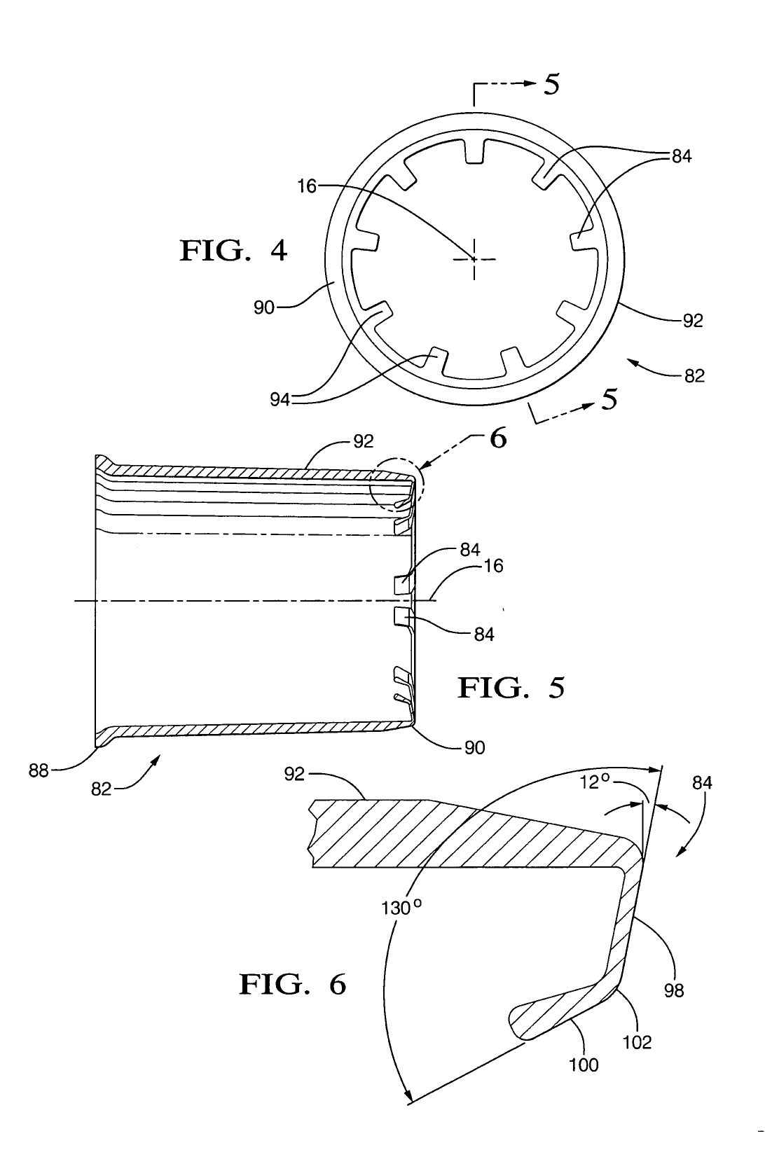

Referring now to FIGS. 4-6, boot shield 82 will be described in more detail. In an exemplary embodiment, boot shield 82 includes nine fingers 84 extending radially inwardly from end 90 defining an integral cylinder 92 defining boot shield 82. The radial inward extension is defined by a first member 98 extending about 12 degrees in toward cylinder 92. Furthermore, an angle of about 78 degrees is formed between cylinder 92 and first member 98.

It will be recognized by one skilled in the pertinent art that end 90 is further defined by tapering of cylinder 92 from which first member 98 extends therefrom as best seen with reference to FIG. 6. In this manner, boot shield 82 is more resilient at this tapered interface between cylinder 92 and finger 84. Although nine equally spaced fingers 84 are illustrated and described, any number and spacing of fingers 84 are contemplated. Each first member 98 is defined having about a ten degree taper toward axis 16 as best shown in FIG. 4. A second member 100 extends from first member 98 forming an angle of about 130 degrees between first and second members 98, 100 as best shown in FIG. 6. Second member 100 is configured to resiliently pivot about an interface 102 between first member 98 and second member 100. In this manner, second member 100 of each finger 84 circumferentially disposed in a valley 104 defined between first convolute 94 and housing 16 where a boot clamp 105 is disposed securing boot shield 82 axially, but allowing shield 82 to rotate relative to boot 80 (See FIG. 3). Alternatively, it will be noted that fingers 84 may be disposed between a valley 106 defined between contiguous convolutes 96.

Boot shield 82 is preferably made from nylon, and more preferably from a heat stabilized nylon. However, it is contemplated that other suitable materials may be employed.

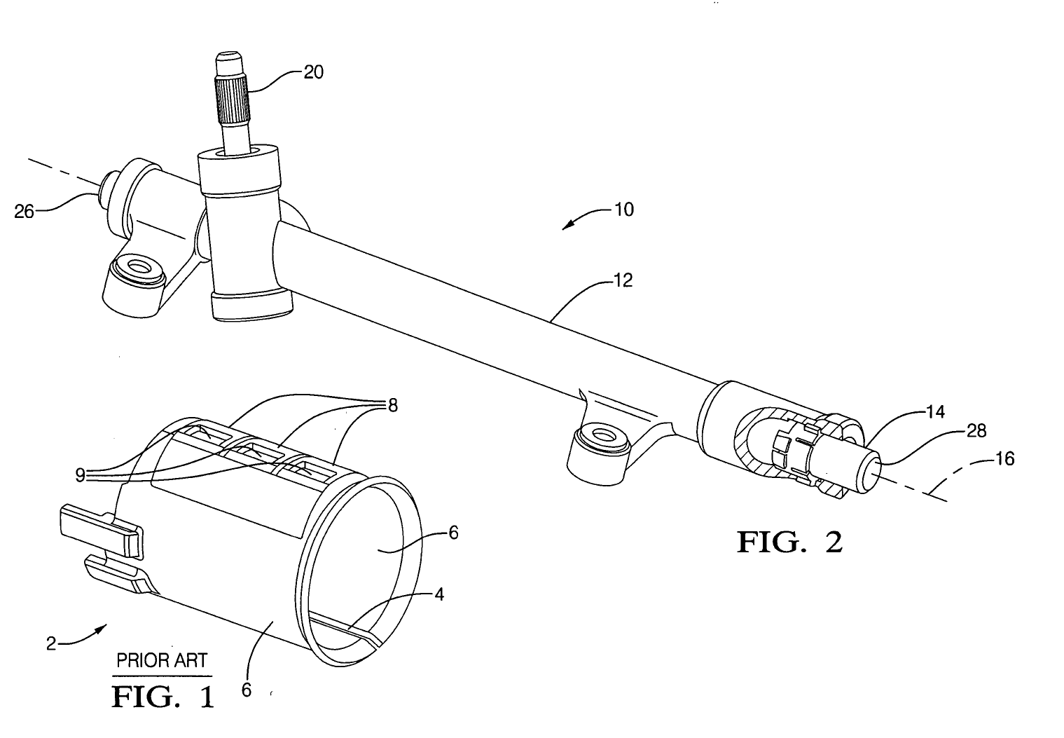

The above described exemplary boot shield replaces the prior art boot shield shown with respect to FIG. 1 that has many features that make it difficult to mold and difficult to assemble. The boot shield in accordance with an exemplary embodiment of the invention also eliminates part-to-part variation associated with the prior art boot shield.

It will be appreciated that the use of first and second or other similar nomenclature for denoting similar items is not intended to specify or imply any particular order unless otherwise stated.

While preferred embodiments have been shown and described, various modifications and substitutions may be made thereto without departing from the spirit and scope of the invention, including the use of geometries other than a cylindrical boot shield. Accordingly, it is to be understood that the apparatus and method have been described by way of illustration only, and such illustrations and embodiments as have been disclosed herein are not to be construed as limiting to the claims.

1. A boot shield for protecting a boot comprising:
a perimetrically continuous tube member open at first and second ends defining a length thereof; and
a plurality of retention features extending radially inwardly from a perimeter defining the tube member, the plurality of retention features configured to resiliently engage a valley defined by a boot convolute of the boot disposed in a hollow cavity defined by the tube member, the plurality of retention features configured to secure the tube member to the boot axially while allowing the tube member to rotate relative to the boot.

2. The boot shield of claim 1, wherein the plurality of retention features are disposed at the first end.

3. The boot shield of claim 2, wherein the second end is flared radially outwardly.

4. The boot shield of claim 1, wherein the plurality of retention features are configured to snap in the valley between a first convolute and a portion of the boot where a boot clamp is positioned.

5. The boot shield of claim 1, wherein the tube member and plurality of retention features are integrally molded.

6. The boot shield of claim 1, wherein the tube member and plurality of retention features are fabricated of nylon.

7. The boot shield of claim 1, wherein each of the plurality of retention features are equidistantly spaced from one another, each retention feature comprising:
a first member extending radially inwardly from the tube member and into a cavity defined by the tube member; and
a second member extending from the first member at an obtuse angle further into the cavity defined by the tube member.

8. The boot shield of claim 7, wherein the first member extends into the cavity forming an acute angle with respect to a portion of the tube member from which it extends.

9. The boot shield of claim 7, wherein the first member includes a narrowing taper defining a width of the first member as the first member extends radially inwardly from the tube member.

10. The boot shield of claim 9, wherein the narrowing taper defining the width of the first member corresponds to opposing edges of the first member forming an angle of about ten degrees relative to each other.

11. A slip on protection system for a boot covering an inner tie rod and steering actuator interface comprising:
a boot having a first end sealingly engaged with a housing of the steering actuator and a second end sealingly engaged with the inner tie rod;
a perimetrically continuous tube member open at first and second ends defining a length thereof; and
a plurality of retention features extending radially inwardly from a perimeter defining the tube member, the plurality of retention features configured to resiliently engage a valley defined by a boot convolute of the boot disposed in a hollow cavity defined by the tube member, the plurality of retention features configured to secure the tube member to the boot axially while allowing the tube member to rotate relative to the boot.

12. The system of claim 11, wherein the plurality of retention features are disposed at the first end.

13. The system of claim 12, wherein the second end is flared radially outwardly.

14. The system of claim 11, wherein the plurality of retention features are configured to snap in the valley between a first convolute and a portion of the boot where a boot clamp is positioned.

15. The system of claim 11, wherein the tube member and plurality of retention features are integrally molded.

16. The system of claim 11, wherein the tube member and plurality of retention features are fabricated of nylon.

17. The system of claim 11, wherein each of the plurality of retention features are equidistantly spaced from one another, each retention feature comprising:
a first member extending radially inwardly from the tube member and into a cavity defined by the tube member; and
a second member extending from the first member at an obtuse angle further into the cavity defined by the tube member.

18. The system of claim 17, wherein the first member extends into the cavity forming an acute angle with respect to a portion of the tube member from which it extends.

19. The system of claim 17, wherein the first member includes a narrowing taper defining a width of the first member as the first member extends radially inwardly from the tube member.

20. The system of claim 19, wherein the narrowing taper defining the width of the first member corresponds to opposing edges of the first member forming an angle of about ten degrees relative to each other.
